(19) United States
(12) Patent Application Publication
(10) Pub. No.: US 2014/0024000 A1
(43) Pub. Date: Jan. 23, 2014

(54) MENTOR SERVICE TERMINAL, MENTOR SERVICE METHOD, AND NON-TRANSITORY COMPUTER READABLE RECORDING MEDIUM STORING THE METHOD

(71) Applicant: Man-Ik Chang, Seoul (KR)

(72) Inventor: Man-Ik Chang, Seoul (KR)

(21) Appl. No.: 14/009,592

(22) PCT Filed: Apr. 8, 2011
(86) PCT No.: PCT/KR11/02475

§ 371 Date: Oct. 3, 2013

(51) Int. Cl. G09B 19/00

(52) U.S. Cl. CPC G09B 19/00
USPC 434/236

(57) ABSTRACT

A mentor service terminal including an input unit, a display unit, and a controller, a mentor service method, and a non-transitory computer readable recording medium storing the method are provided. Users can be allowed to give questions to themselves for their own life, and led to find answers for the questions and roots of their life. On the basis of theses, the users have chance to find solutions to live their successful and happy lives.

### BACKGROUND OF THE INVENTION

1. Field of the Invention

The present invention relates to a mentor service terminal, a mentor service method, and a non-transitory computer readable recording medium storing the method.

2. Description of the Related Art

Typically, people want to live a successful and happy life. However, it is very difficult to creatively imagine such a life, make a concrete plan in a long or short term, and consistently practice the plan.

There are some people who set goals in their own way at the beginning of the year and silently practice to achieve the goals, whereas others do not.

However, beyond the personal level, when many people create and methodically live desired successful and happy lives, many educational problems and various kinds of crime-related problems can be effectively solved and excessive social cost can also be reduced.

Processes and methodologies, which create this kind of personal life, make a concrete plan in a long or short term, and consistently practice the plan, become converged and enabled along with innovative development of digital technologies.

Recently, most people widely use innovative digital devices such as a smart phone or a tablet PC, and can synchronously perform various tasks such as scheduling or email checking by using these devices through networking.

In particular, unlike old generations, a young digital generation having been grown in this digital environment since their childhood desires to have their own differentiated jobs and lives. The young digital generation strongly desires to achieve their dreams (visions) and goals through cooperation with other people by using various networks including the internet. In addition, together with these technical changes, demographic and sociocultural environments are also being changed favorably towards the young digital generation.

### SUMMARY OF THE INVENTION

Accordingly, the present invention is directed to a mentor service terminal, a mentor service method, and a non-transitory computer readable recording medium storing the method that substantially obviate one or more problems due to limitations and disadvantages of the related art, which help users to remove negative thoughts, emotion, and attitude preventing them from achieving goals, create their dreams (visions) on the basis of their own life scenarios, derive methods, namely, goals for achieving their dreams, set intermediate goals by finding out obstacles to be overcome to achieve such goals, allow their daily activities to be linked with the goals, and live desired lives.

According to an aspect of the present invention, there is provided a mentor service terminal including: an input unit receiving information; a display unit displaying information; an information storing unit storing a predetermined control program and mentor information; and a controller executing the predetermined control program, storing the mentor information in the information storing unit in correspondence to an input from the input unit, and providing a mentor service.

The controller may include: an initializing unit performing a control to display, on the display unit, an announcement of inputting negative elements in user's mind and a shape of removing the negative elements input from the input unit; a mentor unit displaying, on the display unit, mentor information allowing the user to creatively draw his/her life scenario and dream, set goals, make concrete plans to achieve the goals, and input the life scenario, dream, goals, and plans through the input unit; and an analyzing unit analyzing how much the concrete plans are followed up, when the user inputs practices in a daily life by using the input unit.

According to another aspect of the present invention, there is provided a method of providing a mentor service in a mentor service terminal comprising an input unit, a display unit, and a controller, the method including: by the controller, receiving negative elements in user's mind from the input unit, and displaying a shape removing the negative elements on the display unit; by the controller, displaying tips helping to draw a life scenario and dream (vision), and set goals on the display unit, and receiving the goals and concrete plans for achieving the goals through the input unit; and by the controller, receiving information on practices performed by the user through the input unit, analyzing how much the concrete plans are followed up, and displaying the analyzed results on the display unit.

The displaying of the tips and the receiving of the goals and concrete plans may include: displaying, by the controller, a guiding notice on the display unit and receiving important factors affecting a user's future life through the input unit; displaying, by the controller, a guiding notice on the display unit and receiving a future scenario type using the important factors; displaying, by the controller on the display unit, the future scenario type and a guiding notice saying to have an insight; displaying, by the controller on the display unit, content of saying to input the user's life scenario on the basis of the future scenario type and the insight; receiving, by the controller on the display unit, the life scenario and displaying content saying to input the dream on the basis of the user's life scenario; receiving, by the controller, the dream and displaying, on the display unit, content saying to input at least one way of achieving the dream; and displaying, by the controller on the display unit, content saying to input obstacles which obstruct achievement of the way, intermediate goals achieved by overcoming the obstacles, and achievement times of the intermediate goals.

The displaying of the analyzed result may further include displaying milestones of the intermediate goals.

According to a still another aspect of the present invention, there is provided a non-transitory computer readable recording medium having a program thereon, which, when executed by a computer, performs the method of providing a mentor service in a mentor service terminal comprising an input unit, a display unit, and a controller, the program including: a function of, by the controller, receiving negative elements in user's mind from the input unit, and displaying a shape removing the negative elements on the display unit; a function of, by the controller, displaying tips helping to draw a life scenario and dream (vision), and set goals on the display unit, and receiving the goals and concrete plans for achieving the goals through the input unit; and a function of, by the controller, receiving information on practices performed by the user through the input unit, analyzing how much the concrete plans are followed up, and displaying the analyzed results on the display unit.

### BRIEF DESCRIPTION OF THE DRAWINGS

FIG. 1 is a configuration diagram of a mentor service terminal according to an embodiment of the present invention.

FIG. 2 is an operation flow chart of a mentor service method according to an embodiment of the present invention.

FIGS. 3 to 19 illustrate exemplary screens displayed on a mentor service terminal display unit according to embodiments of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In the specification, unless explicitly described to the contrary, the word “comprise” and variations such as “comprises” or “comprising”, will be understood to imply the inclusion of stated elements but not the exclusion of any other elements. Also, the terms, such as ‘unit’ or ‘module’, etc., should be understood as a unit that processes at least one function or operation and that may be embodied in a hardware manner, or a combination of the hardware manner and a software manner.

Terminal according to embodiments of the present invention may be digital devices such as PDAs, smart phones, or flat panel computers.

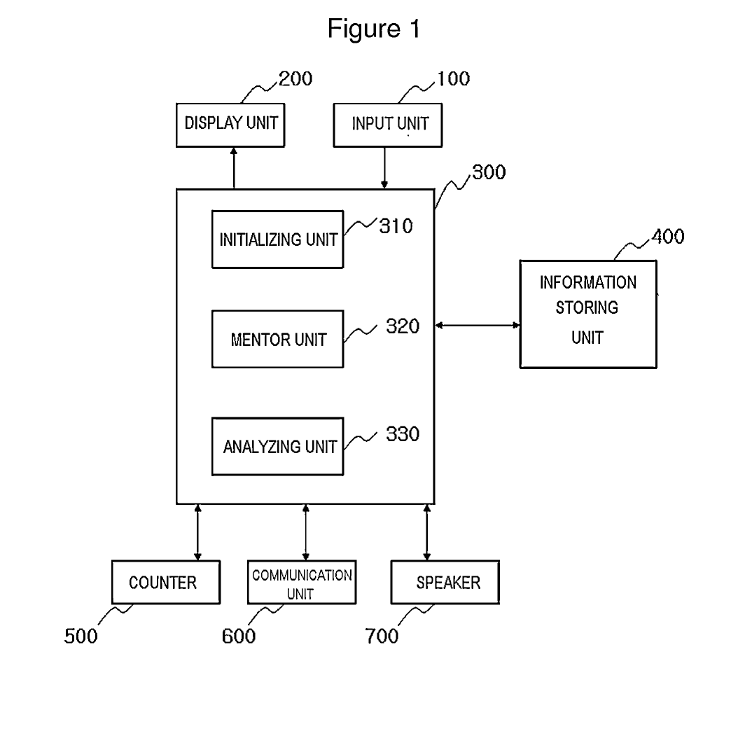

FIG. 1 is a configuration diagram of a mentor service terminal according to an embodiment of the present invention.

Referring FIG. 1, the mentor service terminal according to an embodiment of the present invention includes an input unit 100, a display unit 200, a controller 300, an information storing unit 400, a counter 500, a communication unit 600, and a speaker 700.

The input unit 100 may be a keypad, a touch screen, or a touch pad, which is used to input information.

The display unit 200 displays information and may have the input unit 100 installed on a surface thereof.

The information storing unit 400 stores a control program and pieces of mentor information necessary for a mentor service between screen information for providing the mentor service and input information. The mentor information includes life scenarios and dreams input by a user, ways for achieving the dreams, obstacles and intermediate goals, and various pieces of information for providing the mentor service.

The counter 500 counts the number of certain behaviors, and the communication unit 600 performs mobile communication functions of the terminal.

The controller 300 executes the control program, stores the mentor information in the information storing unit 400 in correspondence to an input from the input unit 100, and provides the mentor service. Here, the controller 300 may be implemented with a central processing unit and a chip set memory to be realized in a form of executing software.

The controller 300 includes an initializing unit 310 performing a control to display an announcement of removing negative elements in user's mind and then display a shape of removing phrases input from the input unit 100 on the display unit 200, a mentor unit 320 displaying the mentor information on the display unit 200 in order to allow the user to creatively draw his/her life scenarios and dreams (visions), set goals, make concrete plans to achieve the goals, and input them through the input unit 100, and an analyzing unit 330 analyzing how much the concrete plans are followed up, when the user inputs practices in a daily life by using the input unit 100.

Hereinafter, a mentor service method executed in the mentor service terminal is described in detail.

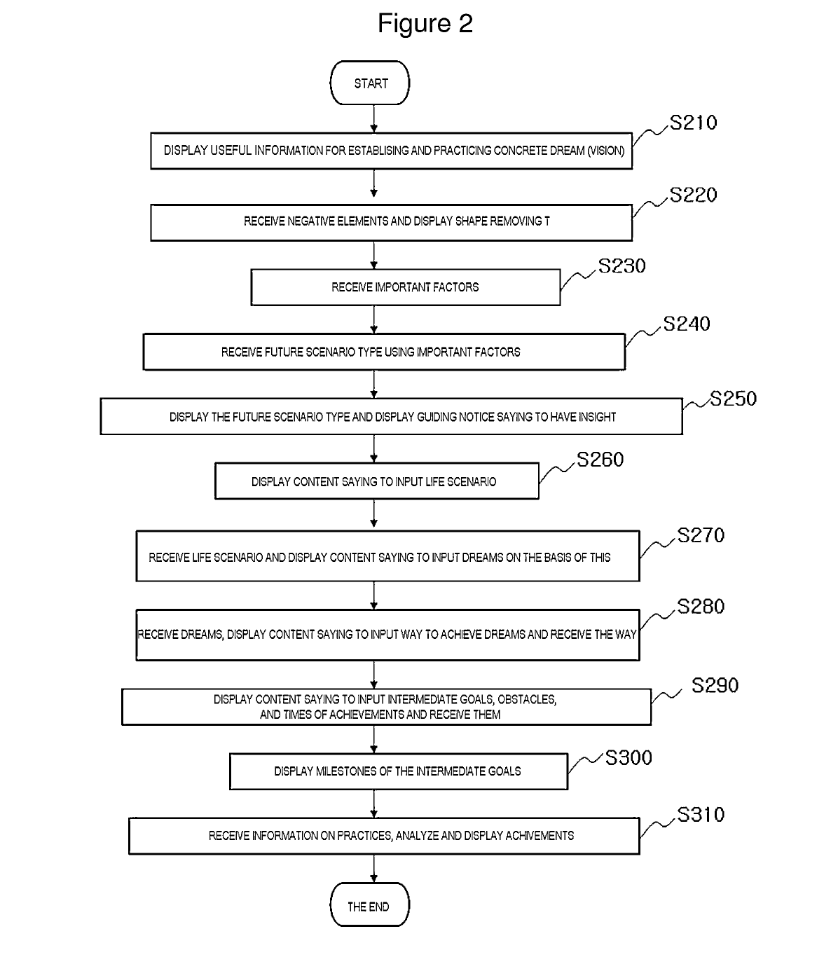

FIG. 2 is a flow chart of the mentor service method.

Referring to FIG. 2, a user turns on the mentor service terminal by manipulating the input unit 100.

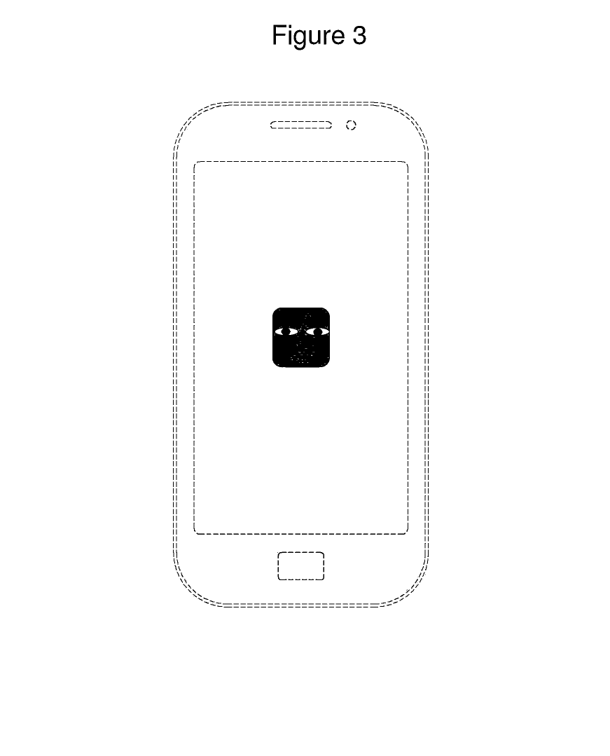

Then, a power is supplied to the mentor service terminal, and an initial screen is displayed as shown in FIG. 3.

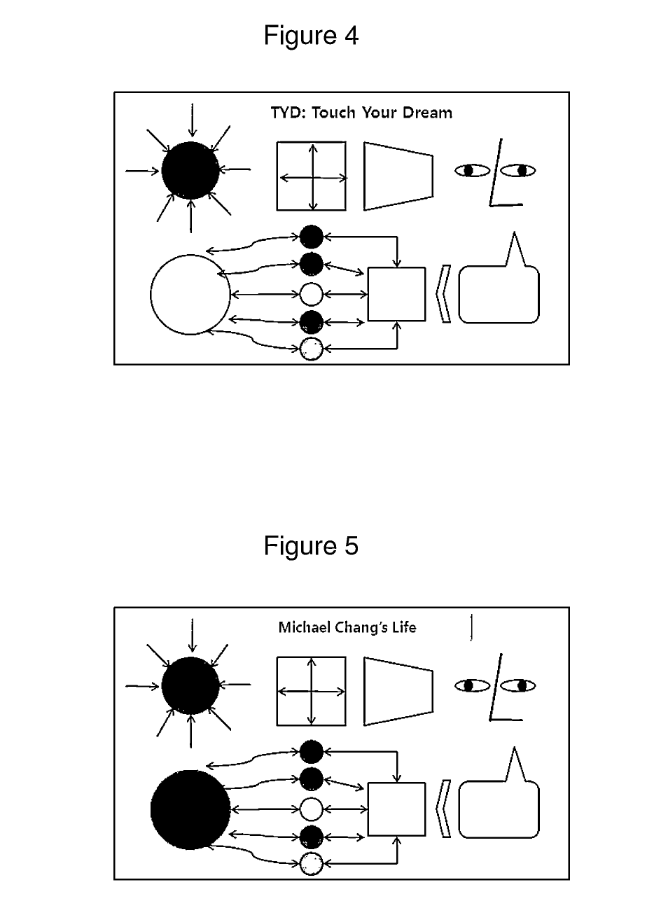

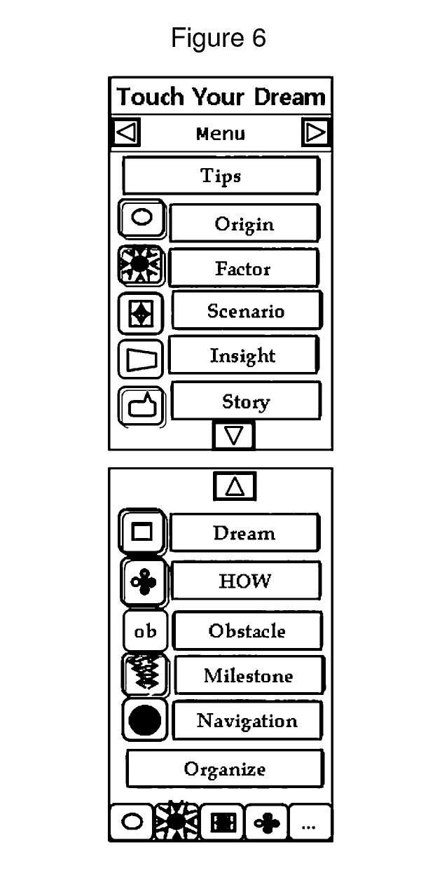

Referring to FIG. 3, when the user selects an icon corresponding to a mentor service method from among various menus by manipulating the input unit 100, the controller 300 displays a detailed screen as shown in FIG. 4 on the display unit 200.

In FIG. 4, pupils may be vivaciously realized to be moved, and the last circle is left empty.

When an entire procedure is completed, the screen like FIG. 4 may be changed to a screen like FIG. 5, and examples of these screens may be variously modified.

Referring to FIG. 5, the controller 300 receives an individual name through the input unit 100 to display it on a top portion, and displays the pupils to be fixed. The last circle is allowed to be filled with red color and glittered. Doing like this allows the user to feel life energy and some achievements. In addition, the controller 300 may adjust and display a screen of FIG. 5 according to achievement.

A first operation is described in detail.

First, when the user executes a mentor service, the controller 300 displays menus in FIG. 5 on the display unit 200.

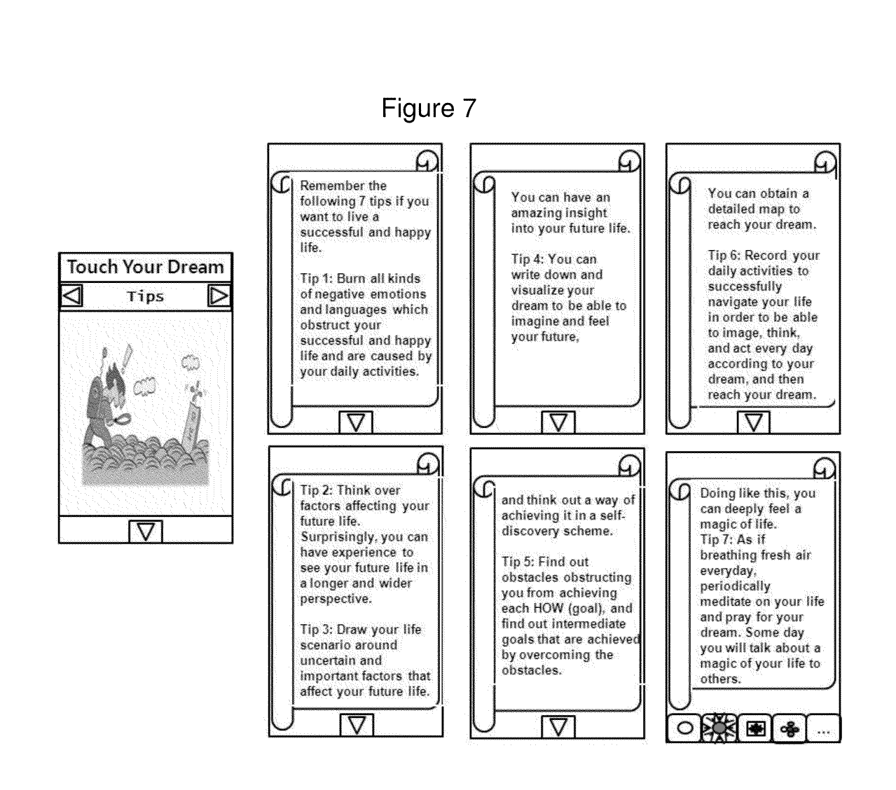

In this menu, when a Tips button is selected, the controller 300 displays tips in a form like FIG. 7 for better understanding for this kind of service, before the user receives the mentor service. This example may be variously modified.

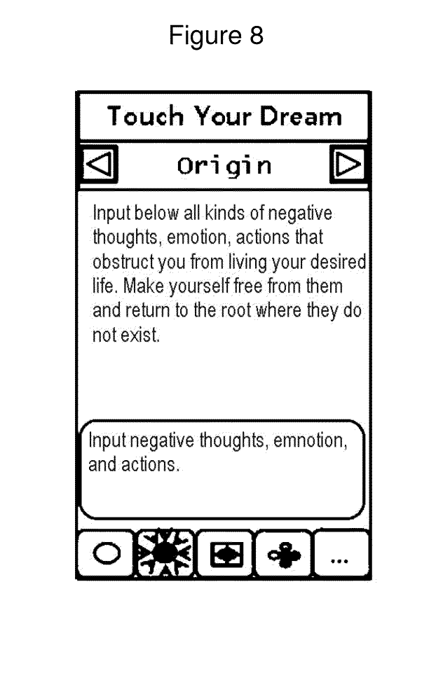

Then, the user selects an Origin button by using the input unit 100, and the initializing unit 310 of the controller 300 displays a screen like FIG. 8.

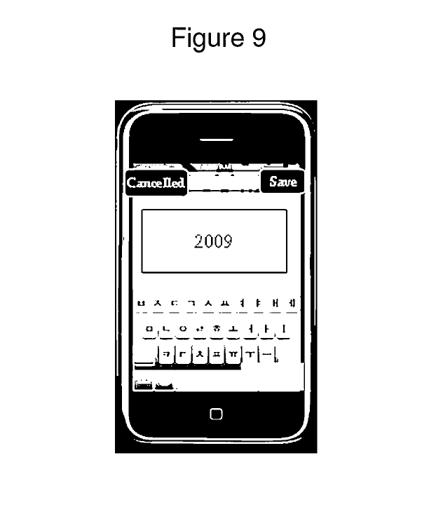

Then, while seeing a guiding screen, the user inputs his/her negative thoughts by using the input unit 100 as shown in FIG. 9.

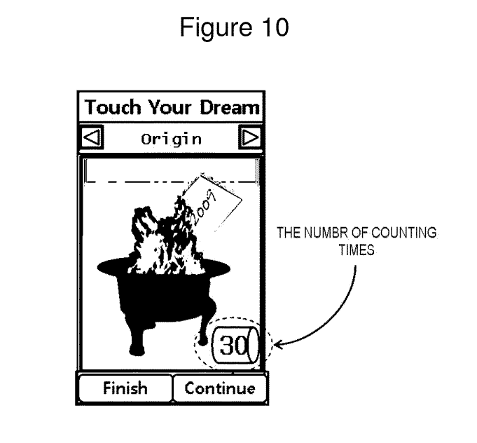

Then, the initializing unit 310 displays, on the display unit 200, a screen that input phrases are burnt as shown in FIG. 10, and outputs a relating sound through the speaker 700 (operation S210). Furthermore, the initializing unit 310 determines and informs that the input phrases are repeated, counts the number of input times of the repeated phrases or sentences through the counter 500, and displays the counted results on a right lower side of the display unit 200. These functions may be audiovisually changed as needed, or may be deleted. The initializing unit 310 may store input phrases in the information storing unit 400.

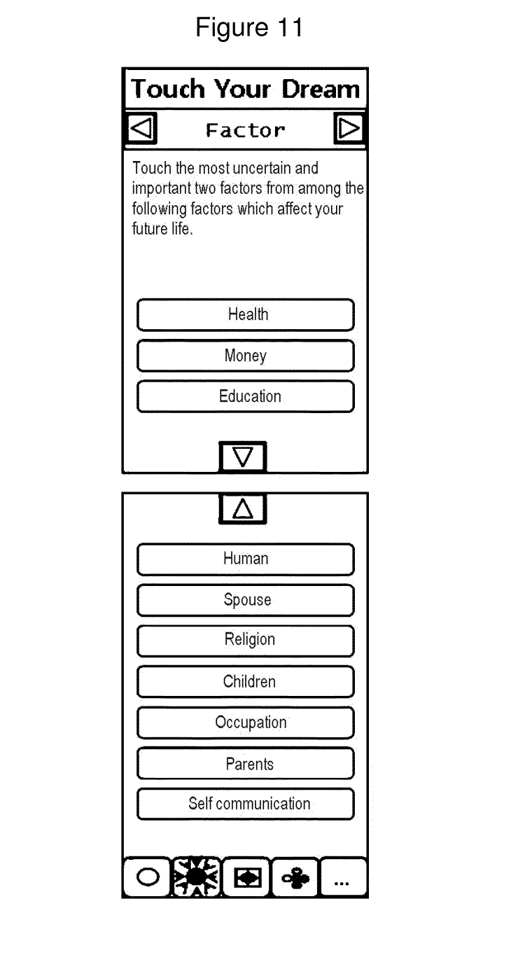

Then, when the user selects a Factor button, the mentor unit 320 displays a notice of FIG. 11 on the display unit 200, and receives about two important factors which affect a user's future life through the input unit 100 (operation S220). When input of this information is completed, the mentor unit 320 stores the input important factors in the information storing unit 400.

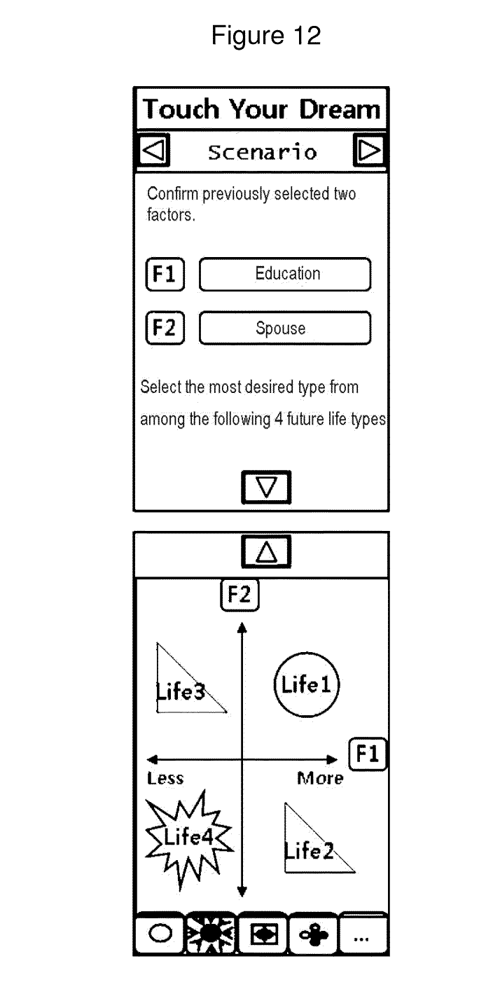

Then, when the user selects a Scenario button, the mentor unit 320 displays a notice of FIG. 12 on the display unit 200 and receives a future scenario type using the important factors through the input unit 100 (operation S230).

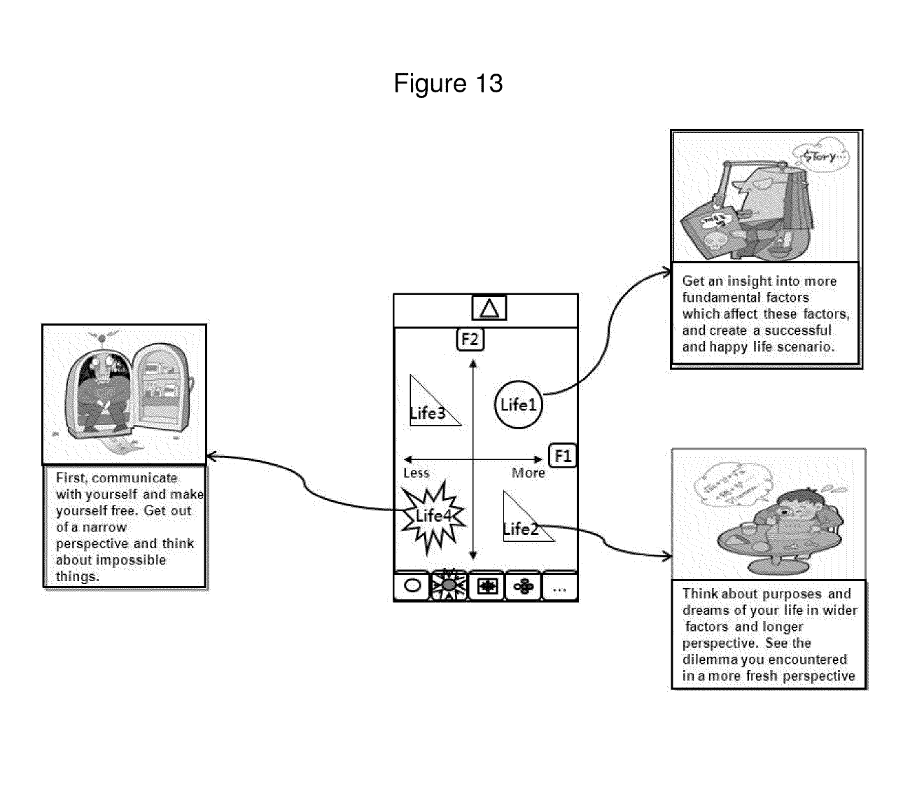

When the user selects an Insight button, the mentor unit 320 displays content like FIG. 13 on the display unit 200 and displays tips allowing the user to have an insight into life for each type of future scenarios using the important factors according to the selection (operation S240). When the input of the information is completed, the mentor unit 320 stores each piece of the future scenario type information in the information storing unit 400.

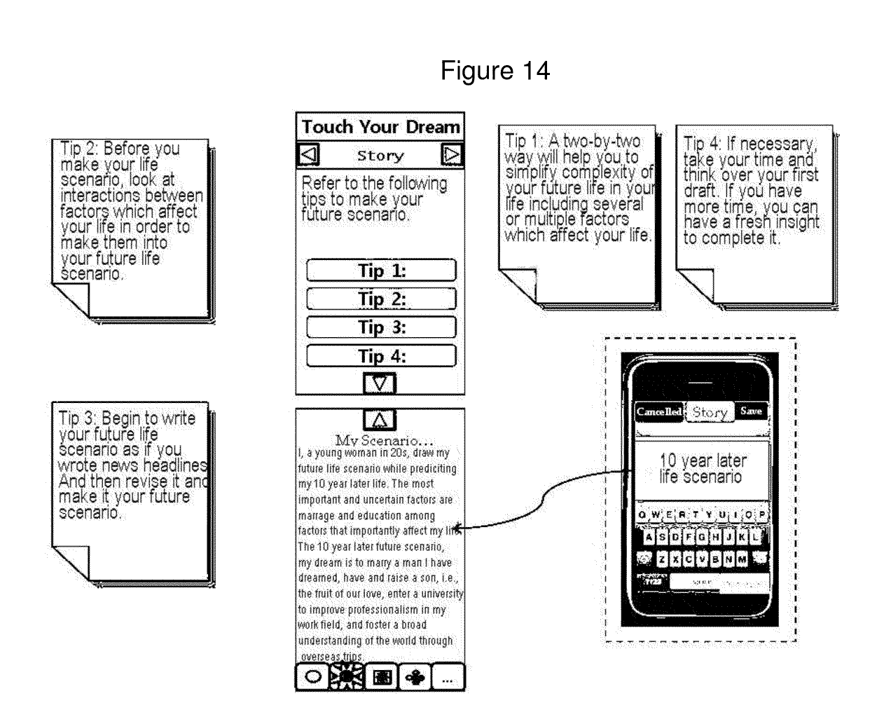

When the user selects a Story button, the mentor unit 320 displays content like FIG. 14 and a notice on the display unit 200. The notice says that the user is allowed to read the tips that he or she has read before drawing his or her future scenario or the future scenario types, and obtain an insight. This operation may be omitted when necessary.

Then, the user inputs his or her own future life scenario on the basis of the future scenario and the notice through the input unit 100. The mentor unit 320 stores the input future scenario in the storing unit 400.

Referring to FIG. 14, the screen displayed on the display unit 200 includes a cancel button and a complete button, and also includes a return button allowing the user to return to an immediately previous operation. These various buttons may be variously configured as needed.

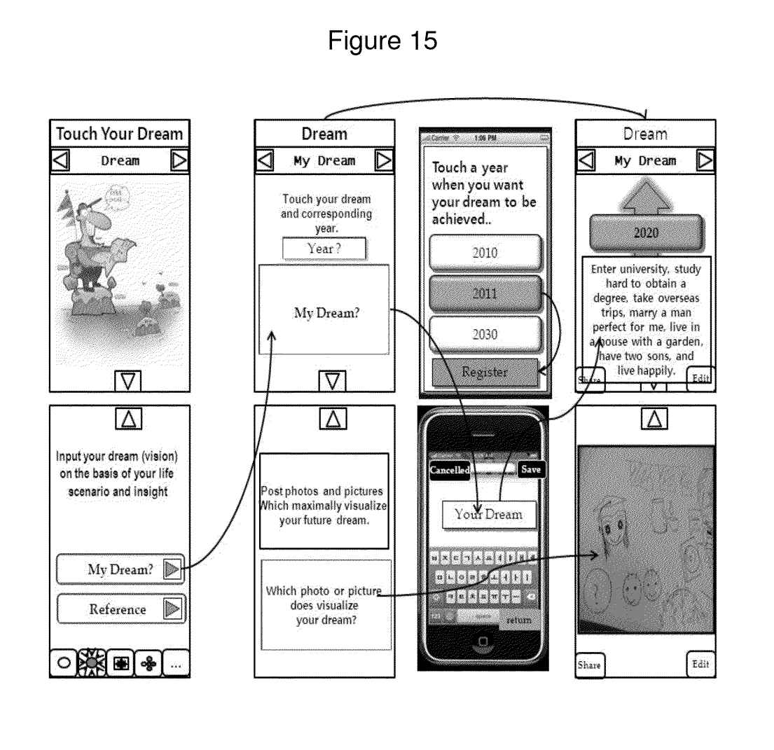

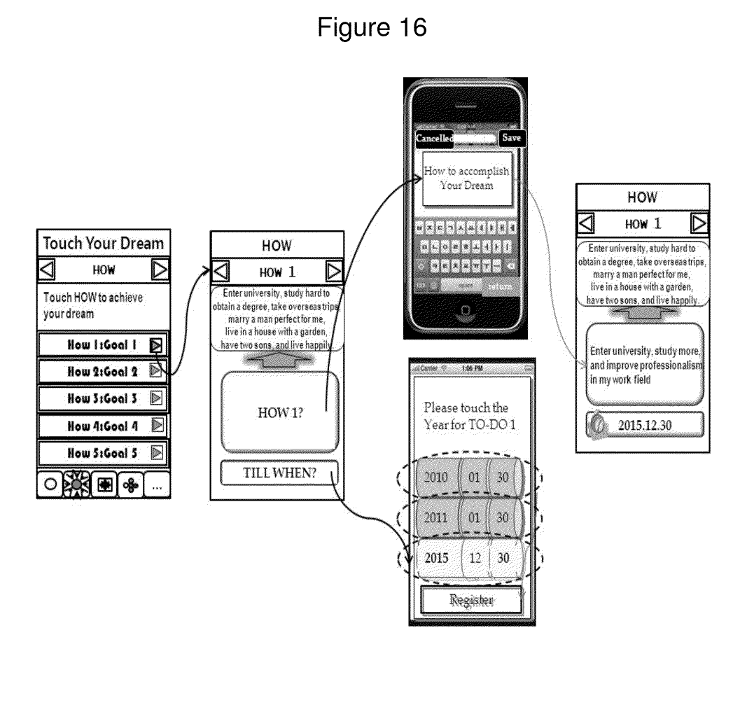

Then, when the user selects a Dream button, the mentor unit 320 displays content of FIG. 15. The content says that the user is allowed to input his or her dream on the basis of the future scenario and the insight (operation S250).

This dream may be input as a picture or a photo, the dream input by the user may be transmitted to those desired to share the dream. When the transmission is necessary, the mentor unit 320 may transmit content including corresponding dream to an external terminal by using the communication unit 600 through a mobile communication network.

Then, when the user selects a How button, the mentor unit 320 displays, on the display unit 200, content that the user is allowed to input at least one way which is an intermediate goal to achieve the dream (operation S260). When this information input is completed, the mentor unit 320 stores the input How information in the information storing unit 400. This content may be variously modified as needed.

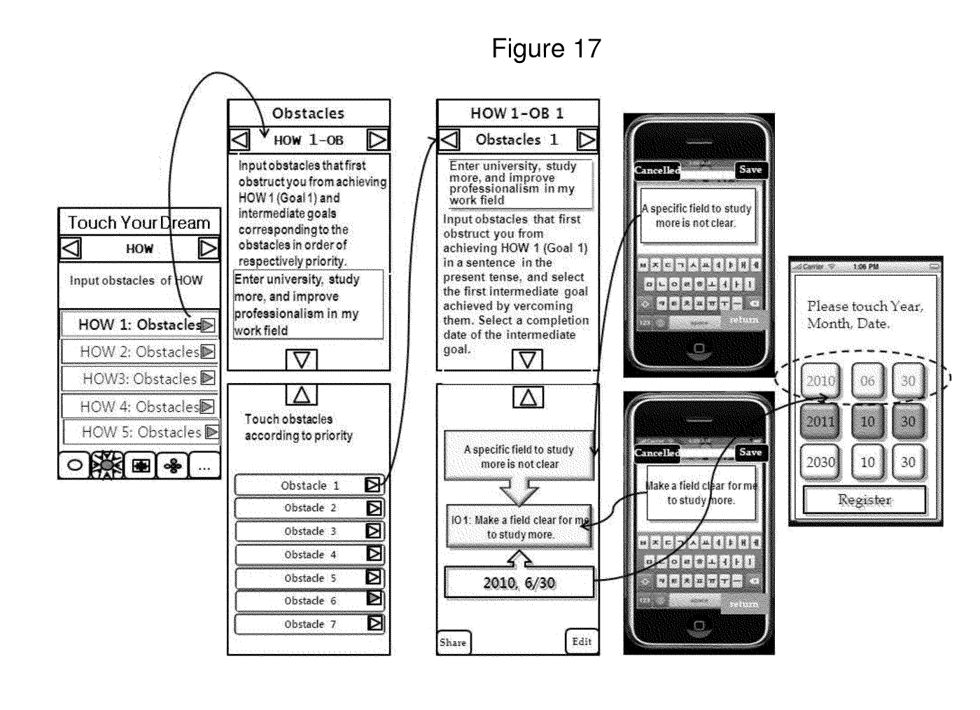

When the user selects an Obstacle button, the mentor unit 320 displays, on the display unit 200, content of FIG. 17 that the user is allowed to input obstacles which obstruct achievement of each How, the intermediate goals achieved by overcoming such obstacles, and the achievement times of the intermediate goals. The user inputs the obstacles, the intermediate goals, and the achievement times through the input unit 100 (operation S270).

Referring FIG. 17, several obstacles may be input for How, and enumerated according to priorities. Schedules thereof may be adjusted by selecting dates. Thus, these realizations may be variously modified. When inputs for the obstacles, intermediate goals, and times of achievements are completed, the mentor unit 320 stores the input obstacles, intermediate goals, and achievement times in the information storing unit 400.

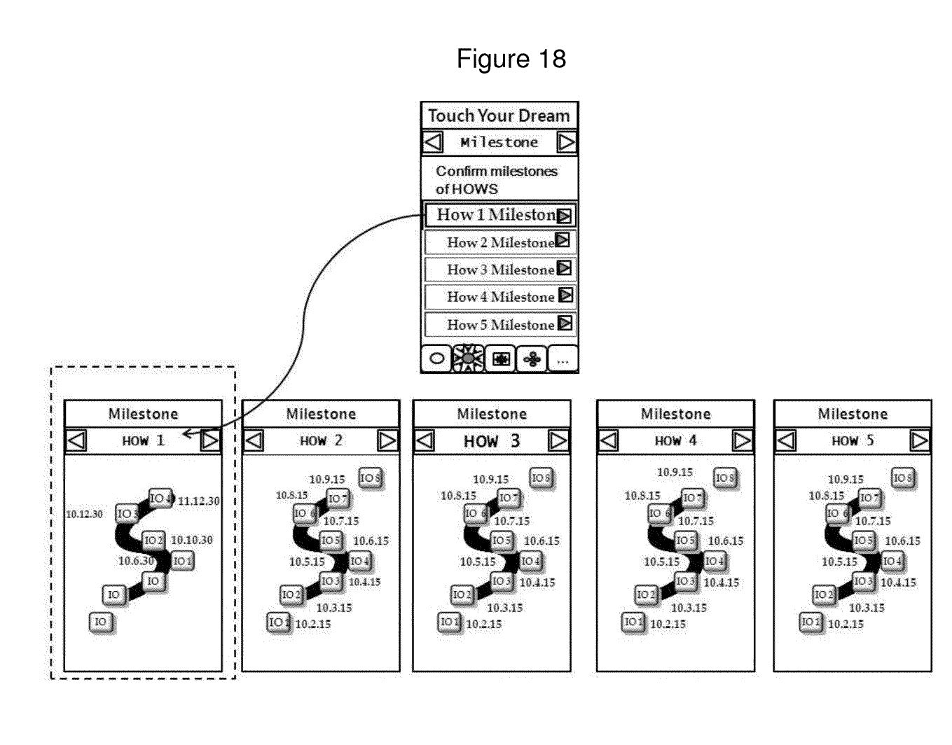

When the user selects a Milestone button on the screen, the mentor unit 320 displays Hows, which are intermediate goals, and how much the intermediate goals are achieved including the dates on the display unit 200 as shown in FIG. 18 (operation S280). From this content, the user may think over future plans to achieve the goals.

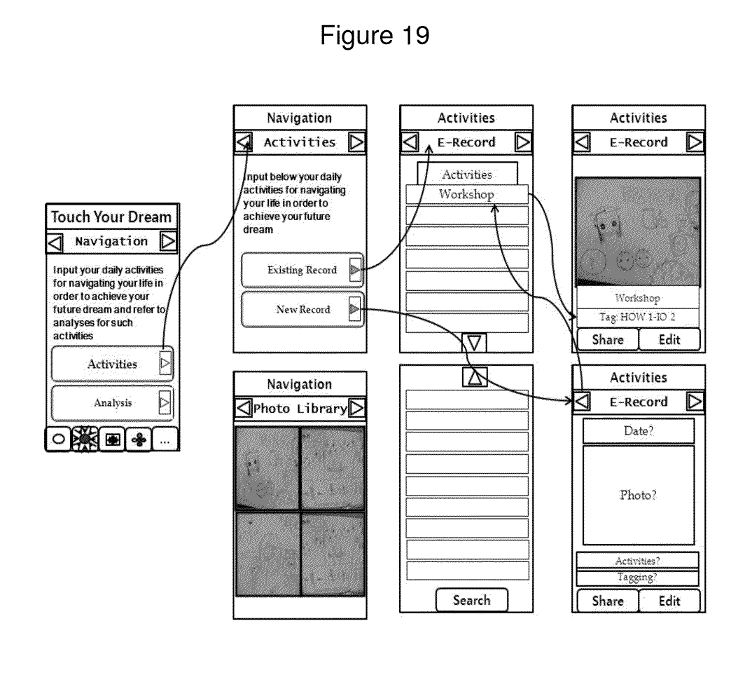

When the user selects a Navigation button, the analyzing unit 330 displays, on the display unit 200, content saying that the user records daily activities as shown in FIG. 19. The user inputs his or her daily activities, and, at this time, tags which one of the concrete intermediate goals the daily activities belong to by using a tagging function. When the input of this information is completed, the analyzing unit 330 analyzes how much the daily activities correspond to the Hows and intermediate goals, and stores the analyzed information in the information storing unit 400.

Here, the analyzing unit 330 allows the user to be able to search or inquire how much Hows for achieving the dreams are achieved in a daily life for each intermediate goal or each date according to a request from the user, or may automatically inform the user of achievement rates as needed (operation S290).

The above described operations do not need to be sequentially performed and their order may be changed by the user as needed. In addition, some operations may be simply realized as one operation.

When the process is terminated after several operations are performed, the controller 300 may store information on the several operations in the information storing unit 400 and display a progress of the operations on an initial screen, namely, the screen of FIG. 5. In addition, on the milestone screen of FIG. 18, the progress of the operations may be also displayed.

According to the embodiments, users may be allowed to give questions to themselves for their own life, and led to find answers for the questions and roots of their life. The embodiment may play a role of a catalyst for change minds, behaviors or attitudes of the users in order for them to live their successful and happy lives. In addition, by sharing experiences, knowledges, wisdoms of users through a network such as the internet in an entire society, educational and learning effects among the users can be increased and a chance can be prepared to preventively and effectively solve various social problems and conflicts.

The above-described mentor service may be variously modified and realized, and may be realized in various forms of receiving a life scenario, dreams and goals, providing tips including various contents in order for the user to achieve the dreams and goals, and checking them.

The above-described screen may be realizable in various languages including English or Korean, and differently realized according to a use target.

The above-described embodiment of the present invention is not embodied only by an apparatus and a method, but may be embodied by a program realizing functionality corresponding to the configuration of the embodiment of the present invention or a recording medium having the program recorded thereon. This may be easily performed by those skilled in the art from the above-described embodiment.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A mentor service terminal comprising:
an input unit receiving information;
a display unit displaying information;
an information storing unit storing a predetermined control program and mentor information; and
a controller executing the predetermined control program, storing the mentor information in the information storing unit in correspondence to an input from the input unit, and providing a mentor service.

2. The mentor service terminal of claim 1, wherein the controller comprising:
an initializing unit performing a control to display, on the display unit, an announcement of inputting negative elements in user's mind and a shape of removing the negative elements input from the input unit;
a mentor unit displaying, on the display unit, mentor information allowing the user to creatively draw his/her life scenario and dream, set goals, make concrete plans to achieve the goals, and input the life scenario, dream, goals, and plans through the input unit; and
an analyzing unit analyzing how much the concrete plans are followed up, when the user inputs practices in a daily life by using the input unit.

3. The mentor service terminal of claim 2, further comprising:
a counter counting the number of input times of the negative elements; and
a speaker outputting a sound when the negative elements are removed,
wherein the initializing unit checks and informs that the negative elements are repetitively input.

4. The mentor service terminal of claim 3, wherein the mentor unit transmits the user's goals to sites designated by the user through a communication unit.

5. A method of providing a mentor service in a mentor service terminal comprising an input unit, a display unit, and a controller, the method comprising:
by the controller, receiving negative elements in user's mind from the input unit, and displaying a shape removing the negative elements on the display unit;
by the controller, displaying tips helping to draw a life scenario and dream (vision), and set goals on the display unit, and receiving the goals and concrete plans for achieving the goals through the input unit; and
by the controller, receiving information on practices performed by the user through the input unit, analyzing how much the concrete plans are followed up, and displaying the analyzed results on the display unit.

6. The method of claim 5, wherein the displaying of the tips and the receiving of the goals and concrete plans comprises:
displaying, by the controller, a guiding notice on the display unit and receiving important factors affecting a user's future life through the input unit;
displaying, by the controller, a guiding notice on the display unit and receiving a future scenario type using the important factors;
displaying, by the controller on the display unit, the future scenario type and a guiding notice saying to have an insight;
displaying, by the controller on the display unit, content of saying to input the user's life scenario on the basis of the future scenario type and the insight;
receiving, by the controller on the display unit, the life scenario and displaying content saying to input the dream on the basis of the user's life scenario;
receiving, by the controller, the dream and displaying, on the display unit, content saying to input at least one way of achieving the dream; and
displaying, by the controller on the display unit, content saying to input obstacles which obstruct achievement of the way, intermediate goals achieved by overcoming the obstacles, and achievement times of the intermediate goals.

7. The method of claim 6, wherein the displaying of the analyzed result further comprises displaying milestones of the intermediate goals.

8. A non-transitory computer readable recording medium having a program thereon, which, when executed by a computer, performs the method of providing a mentor service in a mentor service terminal comprising an input unit, a display unit, and a controller, the program comprising:
a function of, by the controller, receiving negative elements in user's mind from the input unit, and displaying a shape removing the negative elements on the display unit;
a function of, by the controller, displaying tips helping to draw a life scenario and dream (vision), and set goals on the display unit, and receiving the goals and concrete plans for achieving the goals through the input unit; and
a function of, by the controller, receiving information on practices performed by the user through the input unit, analyzing how much the concrete plans are followed up, and displaying the analyzed results on the display unit.
